(19) United States
(12) Patent Application Publication
(10) Pub. No.: US 2026/0016121 A1
(43) Pub. Date: Jan. 15, 2026

(54) Electronic device holder for flat surface

(71) Applicant: Adam Brown, Grand Rapids, MI (US)

(72) Inventor: Adam Brown, Grand Rapids, MI (US)

(21) Appl. No.: 18/769,568

(22) Filed: Jul. 11, 2024

(51) Int. Cl. F16M 13/02; B33Y 80/00

(52) U.S. Cl. CPC F16M 13/022; B33Y 80/00

(57) ABSTRACT

The present invention relates to a holder for securing an electronic device to the flat surfaces. The holder comprises a semi-rigid Top Strap and a semi-rigid base, both adjustable and constructed from durable polymeric materials. The Semi-rigid top strap is designed to fit electronic devices of varying thicknesses and is locked into place using a key mechanism. The Base is attached to the laptop lid or flat surface using adhesive tape and features a semi-rigid Pawl that flexes to allow device insertion and then snaps back to secure the device in place. The holder's design allows for single-motion insertion and extraction of the electronic device, ensuring ease of use and secure attachment. Efficiently manufactured with 3D printing, offering simplicity, durability, and versatility. Ideal for professionals, students, travellers, and remote workers managing multiple electronic devices on laptops or flat surfaces.

### FIELD OF THE INVENTION

The present invention relates to the field of electronic device accessories, specifically to holders designed for securing electronic devices to flat surfaces. This includes, but is not limited to, the back lids of laptop computers. The invention addresses the need for a versatile, secure, and user-friendly solution for attaching electronic devices to various flat surfaces, ensuring stability and accessibility. The holder is particularly suitable for use with laptops, desktops, tables, and other flat surfaces where users need to keep their electronic devices securely in place while allowing for easy insertion and removal. The invention leverages modern materials and manufacturing techniques to offer a practical and durable solution for a wide range of applications.

### BACKGROUND OF THE INVENTION

In today's technologically advanced world, people are increasingly reliant on portable electronic devices such as laptops and electronic devices. These devices are essential tools for communication, productivity, entertainment, and more. However, the need to carry multiple devices simultaneously poses a significant challenge for many users. This challenge is particularly evident among professionals, students, and travellers who often need to transport their laptops and electronic devices together.

Historically, various methods have been developed to address the problem of carrying multiple devices. These methods include the use of pockets, straps, adjustable side-grabbing devices, and dedicated bags or cases. Each of these methods offers certain advantages, but none have effectively addressed the need for a simple, efficient, and secure way to attach an electronic device to the back lid of a laptop computer. This invention aims to fill that gap by providing a holder that allows for easy insertion and removal of an electronic device, while ensuring that the device is securely held in place during transport.

The advent of portable electronic devices such as laptops and electronic devices has revolutionized the way people work, communicate, and entertain themselves. These devices offer unprecedented mobility and convenience, enabling users to perform various tasks on the go. However, this mobility also introduces challenges, particularly in managing multiple devices simultaneously. People with laptop computers almost always also have electronic devices or other electronic devices and, in many cases, need to travel with both.

The need to carry both a laptop and an electronic device has led to various attempts to create solutions for securely holding and accessing electronic devices while using a laptop. Previous methods for holding electronic devices have been disclosed and commercially available, including pockets, straps, or adjustable side-grabbing devices. While these methods provide some utility, they also have limitations that the present invention aims to address.

Several prior art references illustrate different approaches to securing electronic device and other electronic devices to laptops or flat surfaces:

Patent Application Publication No. WO2014/147727A1, discloses a notebook personal computer with a fixation-side case that includes a unit-containing part for holding an HDD unit. The HDD unit has a unit-side connector that connects to a case-side connector, and a regulatory wall part that guides the HDD unit into place. This system ensures a secure connection between the HDD unit and the laptop, but it is designed specifically for internal components and does not address the need for an external holder for mobile phones or other devices. Further, this system does not address the ease of removing devices effectively. Technologies typically require the removal or release of multiple mechanisms to facilitate the removal of devices, such as hard disk drives (HDDs).

U.S. Patent Application Publication No. 2012/0037771A1, describes a device that forms a physical attachment or connection between a laptop or tablet computer and a peripheral device. This device functions as a clip or holder that can be selectively attached to the edge of a laptop or tablet computer. While this solution provides a means of attaching accessories, it relies on clips that may not provide the necessary stability for carrying the laptop and device together. The reliance on clips also means that there is a risk of detachment during movement, which could result in damage to the attached device.

Patent Application Publication No. GB2344940A, discloses a protector members attached to both ends of a portable terminal device, featuring a two-layer structure with an inner rigid layer and an outer softer layer. These protector members have openings to allow access to connectors and operator sections on the device. This design offers protection and access to terminal connectors but does not offer a method for securing external devices to flat surfaces such as a laptop lid. The focus on protecting internal components does not address the need for a versatile holder for external devices. Further, this design does not adequately address both the ease of removing devices and the securing of devices of different thicknesses.

Furthermore, existing solutions for attaching electronic devices to flat surfaces, such as the back lid of a laptop, have several limitations:
Stability and Security: Many existing holders and clips do not provide sufficient stability and security for the attached device. They may detach during movement or handling, risking damage to the device.
Ease of Use: Complex attachment mechanisms can be cumbersome and time-consuming to use. Users need a solution that allows for quick and easy insertion and removal of their devices with minimal effort.
Compatibility: Devices come in various shapes and sizes, and a one-size-fits-all approach may not work effectively. A holder must be adjustable to accommodate different device dimensions.
Durability: Frequent attachment and detachment can wear out the holder or clip, leading to a loss of effectiveness over time. Durable materials and construction are essential for long-term usability.
Flexibility: Holders must be flexible enough to allow for adjustments and repositioning without losing their adhesive properties or structural integrity.

The present invention addresses these limitations by providing a holder for securing an electronic device to the back lid of a laptop computer or any other flat surface. This invention offers several benefits over previous methods for holding a mobile phone or similar device onto the back lid of a laptop computer.

Secure Locking Mechanism: Once inserted, the device is effectively locked in place, ensuring it remains stable when the laptop is carried and moved. This security is crucial for preventing accidental drops and damage.

Single Motion Extraction with a Single Finger: The holder is designed for ease of use, allowing the electronic device to be extracted with a single finger motion. This feature enhances convenience, especially for users who frequently need to access their device.

Two-Piece Design with No Mechanisms: The simplicity of the two-piece design, which includes the Semi-rigid top strap and Base, ensures durability and reduces the risk of mechanical failure. There are no complex mechanisms that could wear out or break over time.

Efficient Manufacturing with Additive Methods: Each of the two pieces can be efficiently manufactured using additive methods such as 3D printing. This approach allows for rapid prototyping, customization, and cost-effective production.

The present invention offers several advantages over the prior art:
Versatile Attachment: The holder can be attached to any flat surface, including the back lid of a laptop, desktops, tables, or other flat surfaces. This versatility makes it suitable for a wide range of applications.
Adjustable and Secure: The Semi-rigid top strap can be adjusted to fit electronic devices of varying thicknesses, ensuring a secure hold. The Key mechanism locks the Semi-rigid top strap in place, providing stability and preventing accidental detachment.
User-Friendly Design: The holder allows for single motion insertion and extraction, making it easy for users to secure and access their devices quickly. This feature is particularly beneficial for users who frequently need to attach and detach their devices.
Durable Construction: The use of semi-rigid polymeric materials ensures that the holder is both flexible and durable. The materials retain their shape and functionality over extended use, making the holder a reliable solution.
Cost-Effective Manufacturing: The ability to manufacture the holder using additive methods such as 3D printing allows for cost-effective production and customization. This efficiency benefits both manufacturers and consumers.

The present invention represents a significant advancement in the field of electronic device holders, addressing the limitations of prior art and offering a versatile, secure, and user-friendly solution for attaching electronic devices to flat surfaces. By leveraging modern materials and manufacturing techniques, the invention provides a durable and cost-effective solution that meets the needs of modern users.

With its innovative design, the holder offers several benefits over existing methods, including ease of use, stability, and versatility. Whether used on the back lid of a laptop, desktops, tables, walls, or vehicle interior, the holder ensures that electronic devices are securely held and easily accessible. This makes it an indispensable tool for professionals, students, travellers, and remote workers who need to manage multiple electronic devices efficiently.

### SUMMARY OF THE INVENTION

The present invention provides an innovative and practical solution for securing an electronic device, such as a mobile phone, to a flat surface, like the back lid of a laptop computer. The invention addresses a common issue faced by many individuals who frequently travel with both a laptop and a mobile phone, offering a streamlined method to keep the phone accessible and securely attached to the laptop. This electronic device holder is especially beneficial for professionals, students, travellers, and remote workers who often need to carry and use multiple electronic devices in conjunction with their laptops or other flat surfaces.

The holder comprises several essential components designed to ensure the device remains securely attached and easily accessible. These components include a semi-rigid top strap, a base, a key mechanism, and an attachment mechanism. Each component plays a crucial role in the functionality and ease of use of the holder, making it a versatile and reliable accessory for managing electronic devices.

The top strap is a semi-rigid element made from a durable polymeric material such as thermoplastic elastomers (TPE), polycarbonate (PC), or acrylonitrile butadiene styrene (ABS). This material choice ensures the necessary flexibility and durability, allowing the top strap to adapt to electronic devices of varying thicknesses. The semi-rigid top strap is designed to fit snugly around the device, with a series of grooves and slots that enable easy adjustment. This adjustability is a key feature, allowing the holder to accommodate different devices, whether they have thick protective cases or are bare and thin.

Once the semi-rigid top strap is adjusted to the desired thickness, it is locked into place using a key mechanism. This mechanism consists of a small protrusion or notch that engages with corresponding slots or grooves in the base. This secure engagement ensures that the semi-rigid top strap remains firmly locked, preventing accidental detachment and providing a stable hold for the electronic device.

The base serves as the foundation of the holder, providing a stable platform for securing the electronic device. Like the semi-rigid top strap, the base is made from a semi-rigid polymeric material, allowing it to flex as needed during the insertion and removal of the device. The base includes an attachment mechanism for securing it to the flat surface of a laptop or other surfaces. This mechanism can be either double-sided adhesive tape or clamp or clip, offering versatility in attachment options. The double-sided adhesive tape provides a strong and reliable bond, allowing for easy removal and repositioning without leaving any residue or damaging the surface.

A critical feature of the base is the semi-rigid pawl, which plays a vital role in securing the electronic device. The pawl is designed to flex downward when the device is inserted, allowing it to pass over the pawl. Once the device is fully inserted, the pawl snaps back to its original position, preventing the device from moving backward and ensuring a secure hold. This mechanism provides an added layer of security, ensuring the device remains firmly in place even when the laptop or other flat surface is moved or carried.

To facilitate the flexing of the base during device insertion and extraction, the ends of the base are designed with adhesive-free zones. These zones allow the base to flex upward, providing the necessary clearance for the device to pass over the semi-rigid pawl. This design ensures smooth and effortless insertion and removal of the electronic device, enhancing the overall user experience.

The key mechanism is an integral part of the holder, ensuring that the semi-rigid top strap remains securely locked in place once adjusted. This mechanism includes a small protrusion or notch that engages with corresponding slots or grooves in the base. The engagement of the key mechanism provides a secure and stable connection between the semi-rigid top strap and the base, preventing accidental detachment and ensuring the electronic device remains securely held in place.

As an adhesive tape can be used to attach the base to the flat surface. The adhesive tape provides a strong and permanent bond, ensuring that the holder remains securely attached. This option is particularly useful for applications where a more permanent attachment is desired. The adhesive tape ensures that the base remains firmly in place, providing a stable platform for the electronic device.

The operation of the holder involves several steps, including the attachment of the base to the flat surface, the adjustment and locking of the semi-rigid top strap, and the insertion and extraction of the electronic device. Each step is designed to be straightforward and user-friendly, ensuring that the holder can be easily used by individuals with minimal effort.

The first step in using the holder is to attach the base to the flat surface of the laptop or other desired surfaces. This can be done using either the clip or clamp or adhesive tape, depending on the user's preference. To attach the base, the user can use adhesive tape to attach the base to the flat surface. The user needs to peel off the protective backing from the adhesive tape and press it firmly onto the desired surface. The adhesive tape will provide a permanent bond, ensuring that the base remains securely attached.

Once the base is securely attached to the flat surface, the next step is to adjust the semi-rigid top strap to the thickness of the electronic device. The user can do this by fitting the semi-rigid top strap into the grooves and slots in the base, ensuring a snug fit around the device. After adjusting the semi-rigid top strap, the user locks it into place using the key mechanism. This involves aligning the small protrusion or notch of the key mechanism with the corresponding slots or grooves in the base and pressing them together until they engage. This engagement ensures that the semi-rigid top strap remains securely locked in place, providing a stable hold for the electronic device.

With the semi-rigid top strap adjusted and locked in place, the holder is ready for use. To insert the electronic device, the user simply needs to drop the device into the holder. The design of the holder allows for single motion insertion with minimal force, making it easy to use. As the electronic device is inserted, it will encounter the semi-rigid pawl in the base. The pawl is designed to flex downward, allowing the device to pass over it. Once the device is fully inserted, the pawl snaps back to its original position, preventing the device from moving backward and ensuring a secure hold.

To remove the electronic device from the holder, the user simply needs to push the device upward. This action causes the semi-rigid top strap and the base to flex, creating the necessary clearance for the device to pass over the semi-rigid pawl. The semi-rigid materials of the top strap and base are designed to flex together when the device is pushed with deliberate force. This coordinated flexing allows the device to pass over the pawl and be easily extracted. Once the device is removed, the semi-rigid top strap and base return to their original shapes, ready for the next use.

The semi-rigid materials used in the construction of the top strap, base, and pawl are carefully selected to ensure they flex only when necessary and return to their original shapes after the force is released. This ensures the durability and longevity of the holder, allowing it to withstand repeated use without losing its functionality. The choice of materials, such as thermoplastic elastomers, polycarbonate, and acrylonitrile butadiene styrene, provides the necessary balance of flexibility and strength, ensuring the holder can securely hold the electronic device while remaining easy to use.

In summary, the present invention offers a practical and efficient solution for securing an electronic device to a flat surface, such as the back lid of a laptop computer. The holder comprises a semi-rigid top strap, a semi-rigid base, a key mechanism, and an attachment mechanism, each designed to ensure the device remains securely attached and easily accessible. The semi-rigid top strap and base are adjustable to accommodate devices of varying thicknesses, and the semi-rigid pawl ensures the device remains securely held in place. The holder can be attached to the flat surface using adhesive tape, offering versatility in attachment options. The operation of the holder is straightforward and user-friendly, allowing for easy insertion and extraction of the electronic device. The materials used in the construction of the holder are carefully selected to ensure durability and longevity, making the holder a reliable and practical accessory for managing electronic devices.

While the primary application of the present invention is for securing electronic devices to the back lid of a laptop, its design also makes it suitable for other flat surfaces. For example:
Desktops and Tables: The holder can be attached to the edge of a desktop or table, providing a convenient location for securing an electronic device within easy reach.
Walls and Panels: By using appropriate adhesive methods, the holder can be mounted on walls or flat panels, offering a secure and accessible place for electronic devices in various environments such as offices, kitchens, or workshops.
Vehicle Interiors: The holder can be used in vehicles to secure electronic devices to flat surfaces such as dashboards or seat backs, providing a safe and accessible location for devices during travel.

### BRIEF DESCRIPTION OF THE ACCOMPANYING DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 illustrates perspective view of the holder for securing an electronic device to a flat surface.

FIG. 2 illustrates a bottom perspective view of the holder for securing an electronic device to a flat surface.

FIG. 3 illustrates the top view of the holder for securing an electronic device.

FIG. 4 illustrates the bottom view of the holder for securing an electronic device.

FIGS. 5 to 10 illustrates perspective view focus on the arrangement and operation of the holder for securing an electronic device.

### DETAILED DESCRIPTION

This disclosure pertains to articles designed for electronic device holder for flat surface, with a particular focus on mobile carrying holder. Various embodiments are detailed with reference to the drawings, where similar reference numerals may denote similar parts and assemblies across the multiple views. Mentioning various embodiments does not restrict the scope of the systems and methods disclosed herein. While examples of construction, dimensions, and materials may be illustrated for different elements, those skilled in the art will recognize that many of the provided examples have suitable alternatives. The examples in this specification are not intended to be limiting but merely illustrate some of the numerous possible embodiments for the systems and methods. It is understood that various omissions and substitutions of equivalents are anticipated as circumstances may suggest or necessitate, but these are intended to encompass applications or embodiments without deviating from the spirit or scope of the disclosure. Additionally, the phraseology and terminology used herein are for descriptive purposes and should not be regarded as limiting.

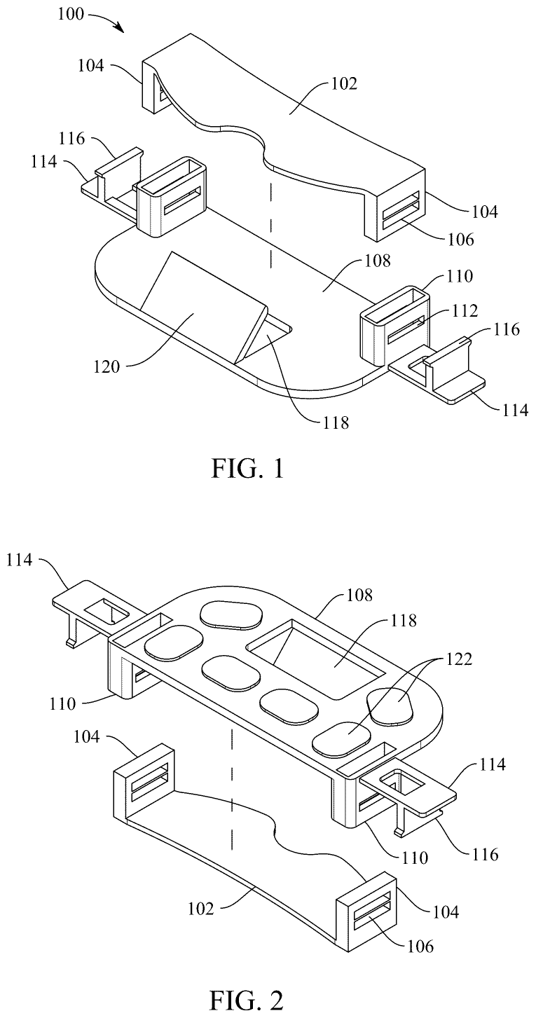

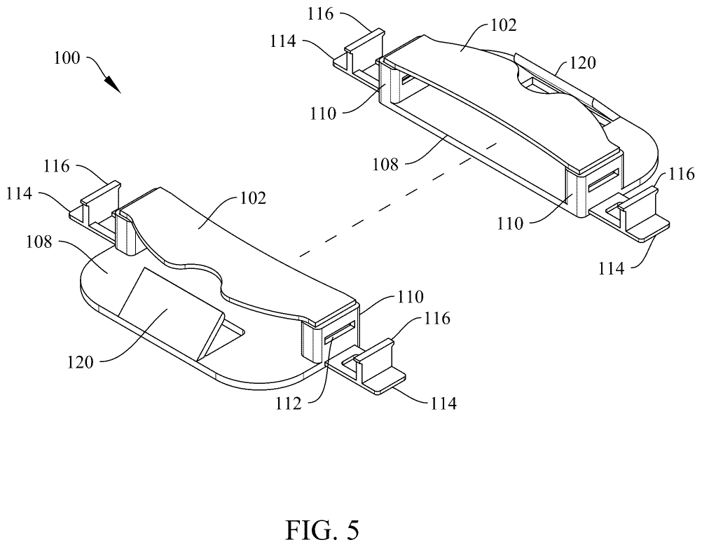

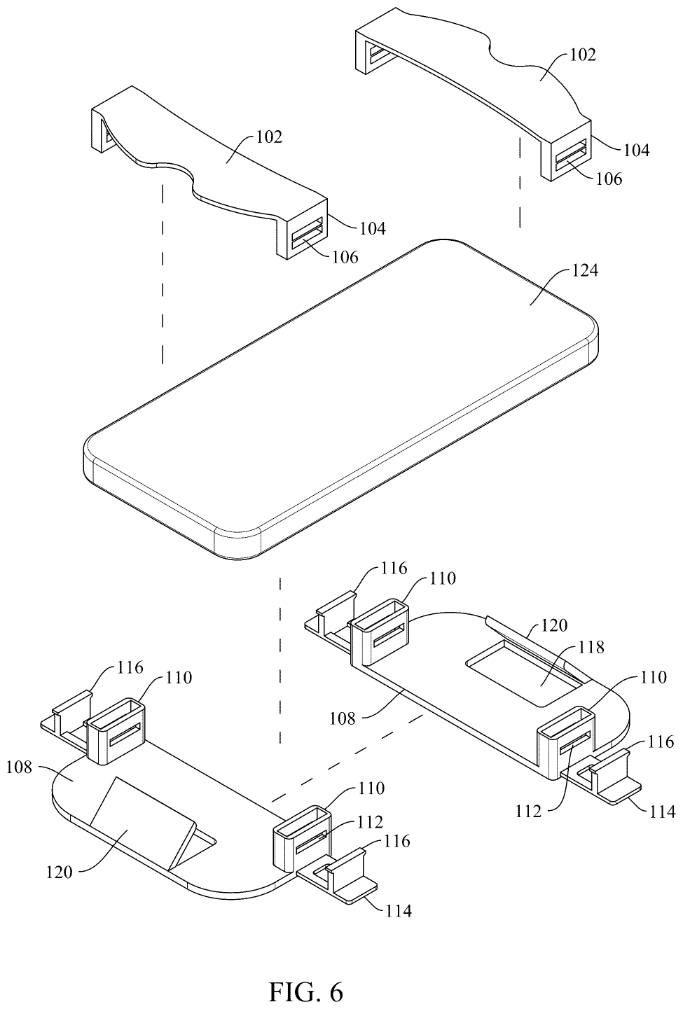

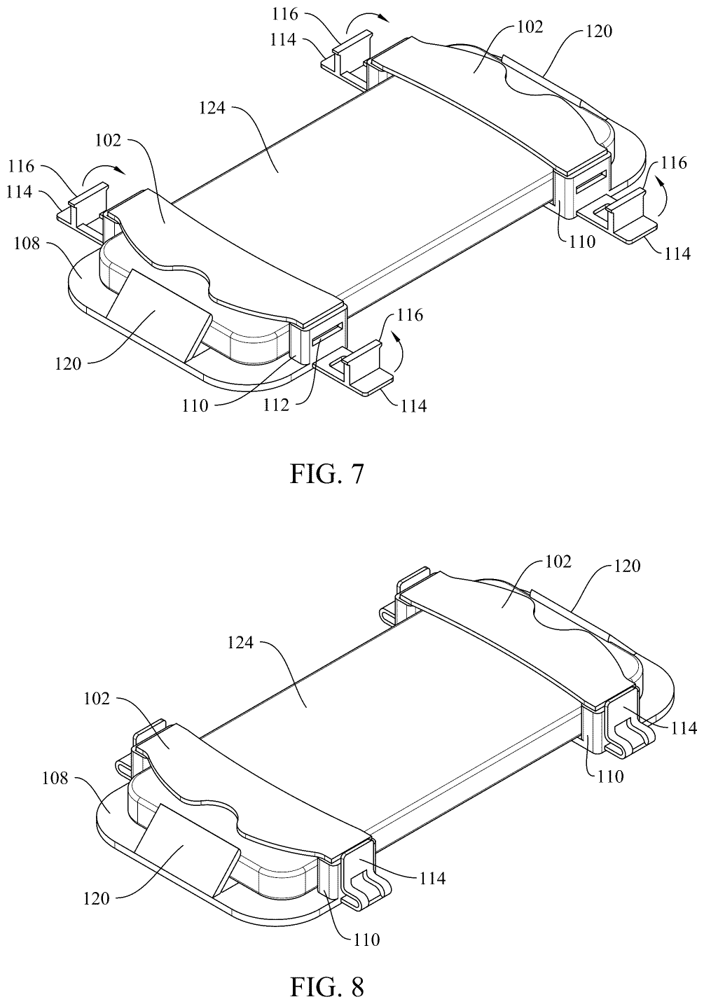

Referring to FIGS. 1 to 10 the present invention provides a holder (100) designed to secure an electronic device (124) to a flat surface (126), such as the back lid of a laptop computer. This holder (100) offers a practical and efficient solution for managing multiple electronic devices, ensuring that they remain securely attached and easily accessible. The holder (100) is particularly beneficial for professionals, students, travellers, and remote workers who need to carry and use multiple electronic devices in conjunction with their laptops or other flat surfaces.

Referring to FIGS. 1 to 2, the holder (100) comprises several key components, each designed to contribute to the overall functionality and ease of use of the device. These components include:

The holder (100) consists of two identical assemblies, each containing a Base (108), a Semi-rigid top strap (102), a Pawl (120), and a Key (116). The Base (108) and top strap (102) are semi-rigid components made from polymeric materials. These materials are chosen for their flexibility and ability to return to their original shape after being deformed.

The Base (108) is designed to be attached to the back of the flat surface (126), such as the back lid of a laptop/computer lid using clip or clamp or double-sided adhesive tape (122). The bottom side of the Base (108) features adhesive spots to ensure a secure attachment while allowing flexibility at the ends. The free end of the Base (108) does not have adhesive to enable upward flexing when the electronic device is inserted or removed.

The Semi-rigid top strap (102) is adjustable to accommodate various electronic device thicknesses, including electronic device with cases. It fits into the Base (108) and is locked into place with a Key (116). The Semi-rigid top strap (102) flexes upward to allow the electronic device to pass over the rotated Pawl (120) during insertion and removal.

The Pawl (120) is a semi-rigid component that plays a crucial role in retaining the electronic device. It allows the electronic device to be inserted by flexing down but then pops up to prevent the electronic device from moving backward. The Pawl (120), along with part of the Base (108), rotates as the electronic device is pushed over it, pushing the electronic device upward into the Semi-rigid top strap (102) and creating a gap to allow the electronic device to pass.

The Key (116) locks the Semi-rigid top strap (102) into place within the Base (108). This ensures that the Semi-rigid top strap (102) remains securely attached, providing a stable and reliable holder for the electronic device.

### Insertion and Removal of the Electronic Device:

Insertion: To insert the electronic device, align it with the holder (100) and push down. The Pawl (120) flexes downward, allowing the electronic device to slide into place. Once the electronic device is fully inserted, the Pawl (120) pops up, preventing the electronic device from moving backward.

Removal: To remove the electronic device, apply a deliberate force to push the electronic device upward. The Semi-rigid top strap (102) flexes upward to facilitate the electronic device's removal. The electronic device can be extracted with a single motion using a single finger.

The electronic device holder (100) is designed to securely attach mobile or any other electronic device (124) to a flat surface (126), such as the back lid of a laptop computer. This holder offers a practical and efficient solution for managing multiple electronic devices, ensuring they remain securely attached and easily accessible. It is particularly beneficial for professionals, students, travellers, and remote workers who need to carry and use multiple electronic devices in conjunction with their laptops or other flat surfaces.

The holder (100) comprises several key components, each contributing to the overall functionality and ease of use of the device. These components include the Semi-rigid top strap (102), Base (108), Key Mechanism (116), Pawl (120), Hook (114) and Key mechanism (116), and Adhesive Tape (122). The Semi-rigid top strap (102) is a crucial element of the holder (100), designed to secure the electronic device (124) in place. It is made from a semi-rigid polymeric material, such as thermoplastic elastomers (TPE), polycarbonate (PC), or acrylonitrile butadiene styrene (ABS), which provides the necessary flexibility and durability. The Semi-rigid top strap (102) is adjustable to accommodate electronic device (124) of varying thicknesses. This adjustability is achieved through a series of grooves and slots that allow the strap to be fitted snugly around the device. The semi-rigid nature of the material ensures that the Top Strap (102) can flex upward to allow the device to pass over it during insertion and extraction. Once adjusted to the desired thickness, the Semi-rigid top strap (102) is locked into place using the key mechanism (116). This key mechanism consists of a small protrusion or notch that engages with corresponding slots or grooves in the Base (108), ensuring a secure hold.

The semi-rigid Base (108) serves as the foundation for the holder (100), providing a stable platform for securing the electronic device (124). Like the Semi-rigid top strap (102), the Base (108) is made from a durable polymeric material, which allows it to flex as needed during the insertion and removal of the device. The Base (108) is designed to be attached to the flat surface (126) of a laptop or other surfaces, but is not limited to, using either hook or clip or clamp or adhesive tape (122). This versatile attachment mechanism ensures that the holder (100) can be securely fixed to various surfaces without damaging them. A key feature of the Base (108) is the semi-rigid Pawl (120), which plays a crucial role in securing the electronic device (124). The Pawl (120) is designed to flex downward when the device is inserted, allowing it to pass over the Pawl (120). Once the device is in place, the Pawl (120) snaps back to its original position, preventing the device from moving backward and ensuring a secure hold. To facilitate the flexing of the Base (108) during device insertion and extraction, the ends of the Base (108) are designed with adhesive-free zones. These zones allow the Base (108) to flex upward, providing the necessary clearance for the device to pass over the semi-rigid Pawl (120).

The Base (108) comprises multiple essential components, each enhancing the device's overall functionality and user convenience. These components consist of a slot (110), a cut-out hole (112), and a hook (114). The Semi-rigid top strap (102) also incorporates key components, such as an end portion (104) equipped with a strap slot (106) for securely fastening the electronic device within the holder (100).

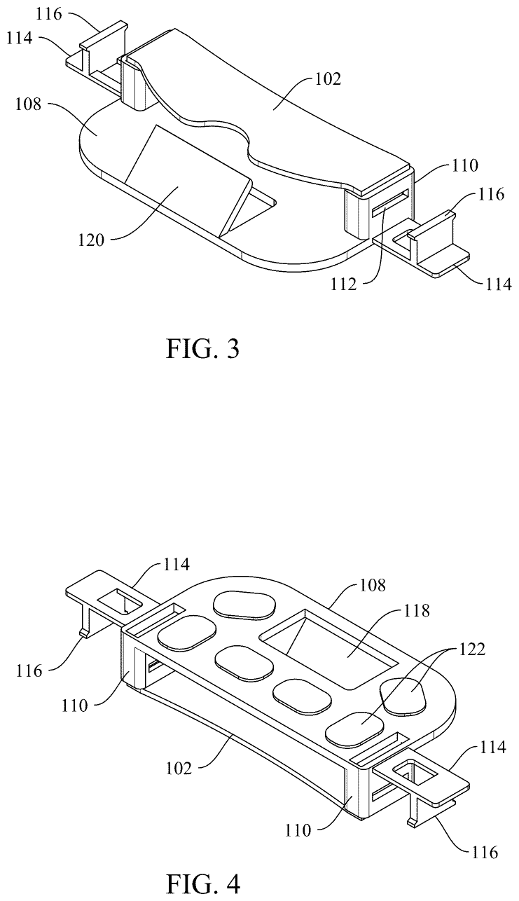

Referring to FIGS. 3 to 8, the key mechanism (116) is located at the hook (114) is an integral part of the holder (100), ensuring that the Semi-rigid top strap (102) remains securely locked in place once adjusted. Firstly, end portion (104) is inserted into the slot (110). Subsequently, depending on their thickness of the electronic device (124), the key mechanism (116) includes a small protrusion or notch that engages with cut-out slot (112) and the strap slot (106) to secure them. The engagement of the key mechanism (116) provides a secure and stable connection between the Semi-rigid top strap (102) and the Base (108), preventing accidental detachment. The adhesive tape (122) provide one of the attachment options for securing the Base (108) to the flat surface (126). These tape offer a strong and reliable bond, ensuring that the holder (100) remains firmly attached to the surface during use. Additionally, the adhesive tape (122) allow for easy removal and repositioning of the holder (100) without leaving any residue or damaging the surface. This option is particularly useful for applications where a more permanent attachment is desired.

The operation of the holder (100) involves several steps, including the attachment of the Base (108) to the flat surface (126), the adjustment and locking of the Semi-rigid top strap (102), and the insertion and extraction of the electronic device (124). Each step is designed to be straightforward and user-friendly, ensuring that the holder (100) can be easily used with minimal effort. The first step in using the holder (100) is to attach the Base (108) to the flat surface (126) of the laptop or other desired surfaces. This can be done using either the hook, or clip or clamp or adhesive tape (122), depending on the user's preference. The user can use adhesive tape (122) to attach the Base (108) to the flat surface (126). The user needs to peel off the protective backing from the adhesive tape (122) and press it firmly onto the desired surface. The adhesive tape (122) will provide a permanent bond, ensuring that the Base (108) remains securely attached.

Once the Base (108) is securely attached to the flat surface (126), the next step is to adjust the Semi-rigid top strap (102) to the thickness of the electronic device (124). The user can do this by fitting the end portion (104) of the Semi-rigid top strap (102) into the slots (110) in the Base (108), ensuring a snug fit around the device. After adjusting the Semi-rigid top strap (102), the user locks it into place using the key mechanism (116). This involves aligning the small protrusion or notch of the key mechanism (116) on the cut-out slot (112) with the corresponding strap slots (106) and pressing them together until they engage. This engagement ensures that the Semi-rigid top strap (102) remains securely locked in place, providing a stable hold for the electronic device (124). With the Semi-rigid top strap (102) adjusted and locked in place, the holder (100) is ready for use. To insert the electronic device (124), the user simply needs to drop the device into the holder (100). The design of the holder (100) allows for single motion insertion with minimal force, making it easy to use. As the electronic device (124) is inserted, it will encounter the semi-rigid Pawl (120) in the Base (108). The Pawl (120) is designed to flex downward, allowing the device to pass over it. Once the device is fully inserted, the Pawl (120) snaps back to its original position, preventing the device from moving backward and ensuring a secure hold.

To remove the electronic device (124) from the holder (100), the user simply needs to push the device upward. This action causes the Semi-rigid top strap (102) and the Base (108) to flex, creating the necessary clearance for the device to pass over the semi-rigid Pawl (120). The semi-rigid materials of the Top Strap (102) and Base (108) are designed to flex together when the device is pushed with deliberate force. This coordinated flexing allows the device to pass over the Pawl (120) and be easily extracted. Once the device is removed, the Semi-rigid top strap (102) and Base (108) return to their original shapes, ready for the next use.

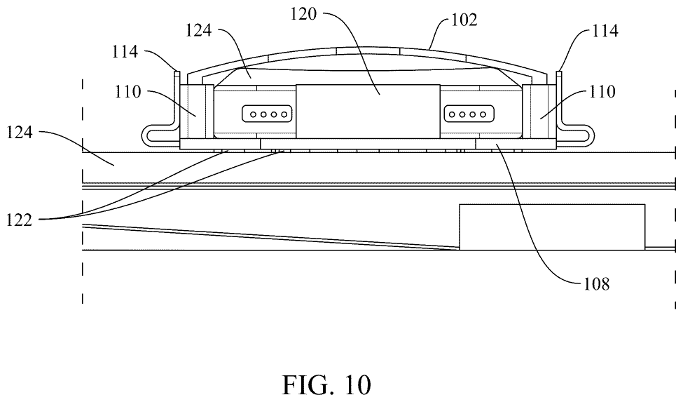

The electronic device holder (100) provides several significant advantages. The single motion insertion and extraction make it easy to use, requiring minimal force and effort. Once inserted, the electronic device is effectively locked in place, preventing accidental dislodging when the laptop is carried and moved. The 2-piece design with no complex mechanisms ensures reliability and ease of manufacturing. Each piece can be efficiently produced using additive manufacturing methods such as 3D printing. The adjustable and flexible Semi-rigid top strap (102) accommodates electronic device of various thicknesses, including those with and without cases as depicted in FIG. 10. This innovative holder significantly improves the convenience and functionality of traveling with both a laptop and an electronic device, ensuring that electronic device remain securely attached and easily accessible.

The holder (100) is designed to be efficiently manufactured using additive methods such as 3D printing. This approach allows for rapid prototyping, customization, and cost-effective production, making it possible to create holders (100) that meet the specific needs of individual users.

The choice of polymeric materials, such as thermoplastic elastomers (TPE), polycarbonate (PC), and acrylonitrile butadiene styrene (ABS), ensures that the holder (100) is both flexible and durable. These materials provide the necessary strength and resilience to withstand frequent use while maintaining their shape and functionality.

### Applications and Use Cases

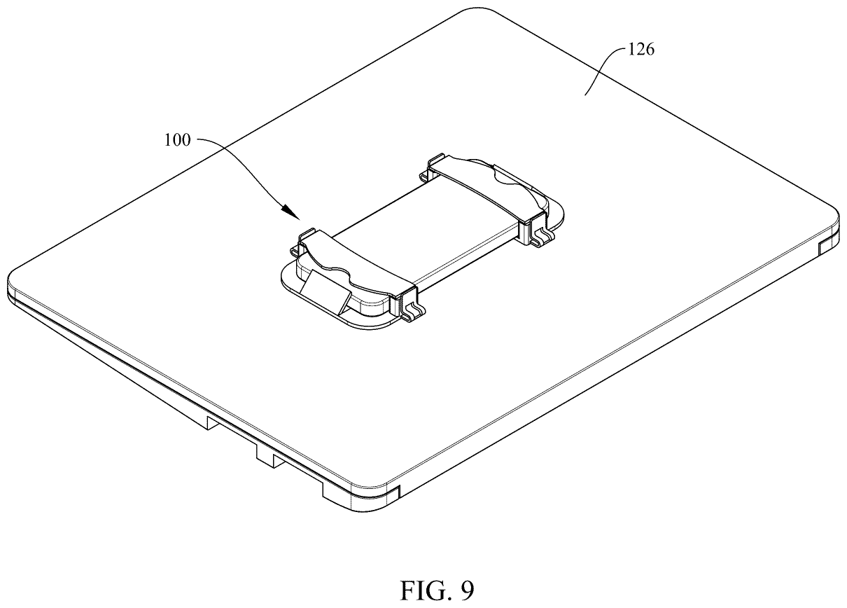

The electronic device holder is designed for a wide range of applications, making it suitable for various user groups and scenarios:
Professionals: Business professionals who frequently travel with their laptops and electronic device can benefit from the holder's secure and convenient design. The holder ensures that the device is readily accessible and protected during commutes and business trips as depicted in the FIG. 9.
Students: Students often carry multiple devices for academic purposes. The holder provides a practical solution for keeping their electronic device securely attached to their laptop, reducing the risk of loss or damage.
Travelers: Travelers who need to manage multiple devices while on the move will find the holder particularly useful. It offers a secure and efficient way to carry their electronic devices without the need for additional bags or cases.
Remote Workers: Remote workers who frequently switch between different work environments can use the holder to keep their electronic device securely attached to their laptop, ensuring a consistent and organized setup.

The present invention represents a significant advancement in the field of electronic device holders, offering a practical, efficient, and secure solution for attaching electronic devices to the back lid of a laptop computer. With its user-friendly design, durable construction, and versatile applications, the holder addresses the limitations of existing methods and provides a superior option for modern users.

The innovative features of the holder, including single motion insertion and extraction, a secure locking mechanism, and a two-piece design with no complex mechanisms, ensure ease of use and long-term reliability. The use of semi-rigid polymeric materials and efficient manufacturing methods further enhance the holder's practicality and cost-effectiveness.

Overall, the electronic device holder is a highly valuable accessory for anyone who needs to carry and use multiple electronic devices in conjunction with their laptop. Its thoughtful design and robust performance make it an indispensable tool for professionals, students, travellers, and remote workers alike.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular, embodiment specifically contemplated, is intended to be practiced in the absence of any element which is not specifically disclosed herein.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A holder for securing an electronic device to a flat surface, comprising:
a semi-rigid top strap adjustable to the thickness of the electronic device;
a semi-rigid base attachable to the back lid of the flat surface,
wherein the base includes an attachment mechanism for securing the base to the back lid of the laptop computer or other flat surface and a semi-rigid pawl designed to flex downward when the electronic device is inserted and snap back into place to prevent backward movement; and
a key mechanism to lock the semi-rigid top strap into the base to ensure the secure holding of the electronic device.

2. The holder of claim 1, wherein the semi-rigid top strap and the base are made from a semi-rigid polymeric material selected from the group consisting of thermoplastic elastomers (TPE), polycarbonate (PC), and acrylonitrile butadiene styrene (ABS).

3. The holder of claim 1, wherein the attachment mechanism for securing the base to the back lid of the laptop computer or other flat surface is selected from the group consisting of hook, clip, clamp and double-sided adhesive tape.

4. The holder of claim 1, wherein the semi-rigid top strap and semi-rigid base are manufactured using additive manufacturing methods such as 3D printing.

5. The holder of claim 1, wherein the semi-rigid top strap is adjustable to accommodate electronic devices of varying thicknesses by fitting into grooves in the base and being locked in place by the key mechanism.

6. The holder of claim 1, wherein the semi-rigid pawl flexes downward when the electronic device is inserted, allowing the device to pass over the pawl, and snaps back into place to prevent backward movement of the device.

7. The holder of claim 1, wherein the key mechanism comprises a small protrusion or notch that engages with corresponding slots or grooves in the base.

8. The holder of claim 1, wherein the base includes adhesive-free zones at the ends to allow for upward flexing during insertion and extraction of the electronic device.

9. The holder of claim 1, wherein the semi-rigid top strap flexes upward to allow the electronic device to pass over the semi-rigid pawl during insertion.

10. The holder of claim 1, wherein the electronic device is extracted by pushing the device upward, causing the semi-rigid top strap and base to flex and allowing the device to pass over the pawl.

11. The holder of claim 1, wherein the semi-rigid materials of the semi-rigid top strap, base, and pawl are designed to flex together only when the electronic device is pushed with deliberate force, and return to their original shapes after the force is released.

12. The holder of claim 1, wherein the semi-rigid top strap and base are designed to ensure the electronic device remains securely held in place even when the laptop or other flat surface is moved or carried.

13. The holder of claim 1, wherein the holder is lightweight and does not add significant weight to the laptop or other flat surface.

14. The holder of claim 1, wherein the holder can be easily removed and repositioned on the back lid of the laptop computer or other flat surface without damaging the laptop or the surface.

15. A method for securing an electronic device to a laptop computer or other flat surface using a holder, comprising:
attaching a semi-rigid base to the back lid of the laptop computer or other flat surface using an attachment mechanism;
adjusting a semi-rigid top strap to the thickness of the electronic device;
inserting the electronic device into the holder by dropping it into the semi-rigid top strap and base;
locking the semi-rigid top strap into the base using a key mechanism to ensure the secure holding of the electronic device; and
securing the electronic device in place using a semi-rigid pawl that flexes downward during insertion and snaps back to prevent backward movement.

16. The method of claim 15, further comprising removing the electronic device by pushing it upward, causing the semi-rigid top strap and base to flex and allowing the device to pass over the semi-rigid pawl.

17. The method of claim 15, wherein the semi-rigid top strap and base are made from a semi-rigid polymeric material selected from the group consisting of thermoplastic elastomers (TPE), polycarbonate (PC), and acrylonitrile butadiene styrene (ABS).

18. The method of claim 15, wherein the attachment mechanism for securing the base to the back lid of the laptop computer or other flat surface is selected from the group consisting of hook, clamp, clip and double-sided adhesive tape.

19. The method of claim 15, wherein the semi-rigid top strap and base are manufactured using additive manufacturing methods such as 3D printing.

20. The method of claim 15, wherein the key mechanism comprises a small protrusion or notch on the semi-rigid top strap that engages with corresponding slots or grooves in the base.
